(19) United States
(12) Patent Application Publication
(10) Pub. No.: US 2004/0198316 A1
(43) Pub. Date: Oct. 7, 2004

(54) Visual display of prepay balance on a mobile station upon registration and post-call

(75) Inventor: Lorie Anne Johnson, London, AR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Compaq Information Technologies Group, L.P., Houston, TX

(21) Appl. No.: 10/176,893

(22) Filed: Jun. 21, 2002

(51) Int. Cl. H04M 11/00

(52) U.S. Cl. 455/406; 455/407; 455/566; 455/435.1; 455/432.1

(57) ABSTRACT

A subscriber's prepay balance is provided to a wireless mobile station (e.g., a cellular telephone) for visual display to a subscriber. Preferably, the prepay balance information is retrieved by a prepay application and, rather than be provided to an interactive voice response unit for conversion into an audible message, the prepay balance is provided through the network to the mobile station itself and displayed thereon. The prepay balance can be provided upon registering the mobile station with the carrier's network and/or upon completion of a phone call. In this way, within a relatively short period of time following the termination of a phone call or during registration, the subscriber's mobile station automatically displays the new prepay balance.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to wireless services. More particularly, the present invention relates to displaying prepay balance information on the display of a mobile wireless station (e.g., cell phone). Still more particularly, the invention relates to retrieving and displaying prepay information on a mobile station during the registration process and upon completion of a call.

2. Background Information

As with most things in life, cellular telephone service is available for a price. Typically, the pricing of cell phone service is based on time of usage—the more the cell phone is used (both to receive and make calls), the more it costs. More specifically, cell phone pricing typically is based on the number of minutes of actual usage.

Currently, many service plans provide the subscriber with an agreed upon number of minutes to use per month. The monthly price of the plan depends on the number of minutes selected by the subscriber in his or her plan. Some service plans permit the subscriber to prepay the service. Once the prepaid number of minutes has been exhausted, the service may cease until the subscriber prepays for more minutes.

For obvious reasons, it is desirable for a subscriber to know how many minutes remain in the prepaid service plan. Currently, various carriers provide prepay balance information to the subscriber via an audible message using a mechanism referred to as interactive voice response (“IVR”). The balance may be provide in units of time or money. A prepay application accessible on the wireless network computes the length of each of the subscriber's calls and uses that information to keep track of the amount of prepaid time remaining in the subscriber's prepaid service plan. When the subscriber terminates a call, the switch to which the mobile station is registered sets up a call to an UVR unit. A prepay application is queried for prepay information (e.g., remaining balance) relevant to the subscriber. The prepay application provides the prepay information to the IVR unit along with a message to provide the subscriber. The IVR unit embeds the subscriber's prepay information in the message and converts the message to an audible form. The audible message is then provided to the subscriber.

The voice-based prepay feedback mechanism described above is generally satisfactory, but does have its deficiencies. For instance, following the completion of a call the time required for the prepay information to be provided to the IVR unit and the IVR unit to transmit an audible message to the subscriber is annoyingly long (e.g., 30 seconds or more). Further still, the implementation and use of the IVR unit is fairly complex and expensive. Also, if the user is not paying attention when the audible message is played, he or she will miss the prepay balance information. Accordingly, it would be highly desirable to provide prepay information to a subscriber in a much quicker, easier, and more cost and robust effective manner.

### BRIEF SUMMARY OF THE PREFERRED EMBODIMENTS OF THE INVENTION

The problems noted above are solved in large part by providing a subscriber's prepay balance information to a wireless mobile station (e.g., a cellular telephone) for visual display to a subscriber. Preferably, the prepay balance information is retrieved by a prepay application and, rather than be provided to an interactive voice response unit for conversion into an audible message, the prepay balance is provided through the network to the mobile station itself and displayed thereon. The prepay balance can be provided upon registering the mobile station with the carrier's network and/or upon completion of a phone call. In this way, within a relatively short period of time following the termination of a phone call or during registration, the subscriber's mobile station automatically displays the new prepay balance. The subscriber advantageously does not need to wait for, and listen to, an audible, ephemeral message providing the desired prepay balance information.

In accordance with one embodiment of the invention, a method of providing prepay balance information to a wireless service subscriber's mobile station comprises sending a registration message to initiate registering the mobile station; receiving a message containing information indicative of the subscriber's current prepay balance; and displaying said information on a display associated with said mobile station.

In accordance with another embodiment of the invention, a wireless network providing wireless services to which subscribers subscribe comprises a mobile station containing a display; a switch to which the mobile station wireless communicates; and a prepay application to which the switch communicates. The prepay application provides a representation of a subscriber's prepay balance through the switch to the display of the mobile station.

The problems noted above are addressed with the preferred embodiments described herein. These and other advantages will become apparent upon reviewing the following disclosure.

### BRIEF DESCRIPTION OF THE DRAWINGS

For a detailed description of the preferred embodiments of the invention, reference will now be made to the accompanying drawings in which:

FIG. 1 shows a preferred embodiment of providing a visual indication of a subscriber's prepay balance during the registration process; and

FIG. 2 shows a preferred embodiment of providing a visual indication of a subscriber's prepay balance upon completion of a phone call.

### NOTATION AND NOMENCLATURE

Certain terms are used throughout the following description and claims to refer to particular system components. As one skilled in the art will appreciate, computer, wireless device and service companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to.”. Also, the term “couple” or “couples” is intended to mean either a direct or indirect electrical connection. Thus, if a first device couples to a second device, that connection may be through a direct electrical connection, or through an indirect electrical connection via other devices and connections. To the extent that any term is not specially defined in this specification, the intent is that the term is to be given its plain and ordinary meaning.

### DETAILED DESCRIPTION OF THE PREFERRED EMBODIMENTS

In accordance with a preferred embodiment of the invention, a visual representation of prepay information is provided by a prepay application directly to a mobile station and displayed thereon. Because an audible message is not needed to provide the prepay information, the use of an IVR unit as in conventional systems is not needed. Consequently, the complexity and time delay associated with the IVR mechanism is avoided.

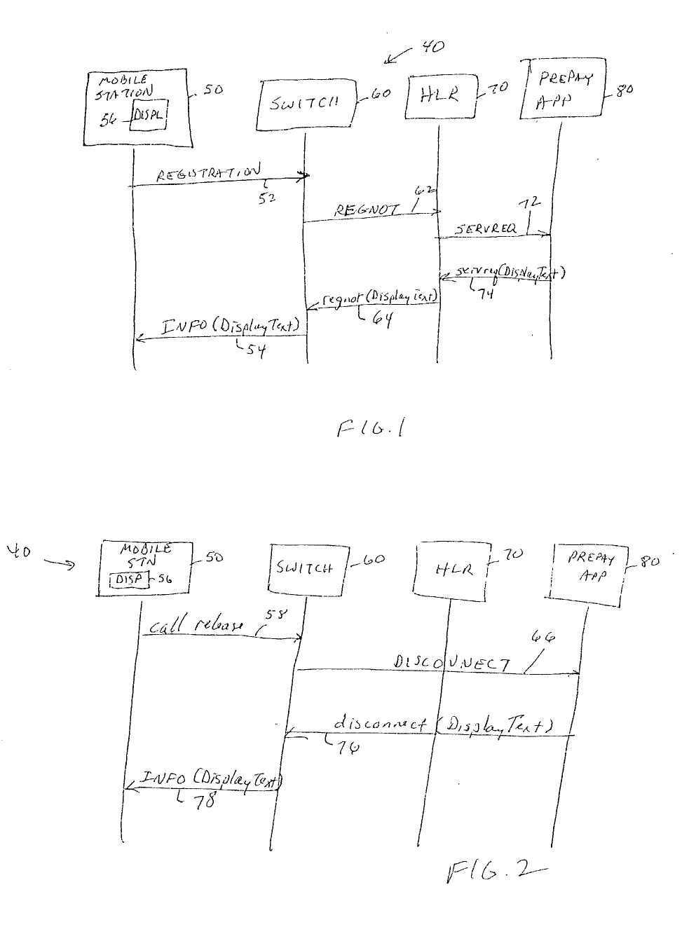

Numerous implementations of the preferred embodiment are possible and all such implementations should be considered as part of this disclosure and the claims which follow. FIGS. 1 and 2 illustrate one such preferred embodiment. Both Figures show a wireless network comprising a mobile station 50, a switch 60, a home location register 70 and a prepay application 80.

FIG. 1 depicts an embodiment of a wireless network 40 in which a visual representation of prepay information is provided to and shown on a display 56 included as part of, or coupled to, a mobile station 50. Mobile station 50 may be a cellular telephone and display 56 may be the phone's display as would be well known. The embodiment of FIG. 1 shows how prepay information can be provided to the mobile station 50 during the registration process. The registration process is the process that occurs when the mobile station is powered on by which the mobile station 50 associates itself with a switch 60. In general, because, by definition, mobile stations are transportable, the wireless network 40 must know the location of the switch 60 to which the mobile station 50 is currently registered. This location information is necessary for the network to effectively complete calls to or from the mobile station. As is well known, the home location register (“HLR”) 70 is a database that generally performs the function of maintaining an entry for each subscriber to the carrier's service. Among other things, the HLR 70 keeps track of the current location of the mobile station.

Referring still to FIG. 1, during the registration process, the mobile station 50 sends a registration signal 52 to the switch 60. The registration signal 52 may be issued upon powering up the mobile station 50 or at other times, such as periodically. The switch 60 responds by issuing a registration notification (“REGNOT”) message 62 to the HLR which provides the station's location information as noted above. In accordance with the preferred embodiment of the invention, the HLR 70 then issues a service request (“SERVREQ”) message 72 to the prepay application 80. The SERVREQ message 72 includes an identifier unique to the subscriber's mobile station and also informs the prepay application, in the case of a power on event, that the subscriber has powered on his or her mobile station 50. The station's unique identifier may be any suitable identifier such as, in the context of ANSI networks, an international mobile subscriber identity (“IMSI”) or mobile identification number (“MIN”) which is used to identify the mobile station to the network. The prepay application 80, which itself is a database running on a computer, retrieves the applicable prepay information for the subscriber identified in the SERVREQ message 72 and responds to the HLR 70 by issuing a SERVREQ response message 74, which is shown in lower case letters to indicate that it is a response message.

The servreq response message 74 includes a representation of the subscriber's prepay information. In one embodiment, the prepay representation may comprise a binary encoded string which represents the prepay information. Alternatively, the prepay representation could be an ASCII string, or any other desired representation. The prepay representation is depicted in FIG. 1 as “DisplayText.” The DisplayText string may be just the prepaid balance or a text message in which the balance is embedded such as “Your current account balance is 125 minutes.” The prepaid balance may be provided in units of time or money.

The DisplayText information is then passed on by the HLR 70 to the switch 60 in responsive message to the REGNOT message 62. This responsive message is shown as regnot 64 which includes, at least as one of its parameters, the DisplayText information. Subsequently, the switch 60 sends an INFO message 54 to the mobile station 50. As shown, the INFO message 54 also includes the DisplayText information which the mobile station retrieves from the INFO message and shows on its display 56.

The REGNOT, SERVREQ, regnot, servreq and INFO messages are well known in the ANSI standards. The embodiment shown in FIG. 1 thus advantageously uses existing messaging mechanisms to implement the functionality described herein.

In this manner, prepay information is provided to the mobile station 50 during the registration process in a fast and efficient manner. A subscriber might also desire to be informed of his or her prepay balance upon the completion of each phone call. The embodiment shown in FIG. 2 provides this feature.

Referring to FIG. 2, when a call is made to or by a subscriber, the time duration of the call is measured in accordance with any well known manner. For example, the prepay application 80 may be provided a call initiation message which causes the prepay application to begin measuring the time duration of the phone call. Upon termination of the phone call, the mobile station 50 sends a call release message 58 to the switch 60. The switch 60 then sends a DISCONNECT message 66 to the prepay application 80. The prepay application 80 receives the DISCONNECT message 66, determines the elapsed time duration of the current phone call, and subtracts the elapsed time from the subscriber's prepay balance to determine the new balance. The prepay application 80 then issues a disconnect response message 76 to the switch 60. The disconnect response message 76 includes DisplayText information which, as described above, provides a visual representation of the subscriber's new prepay balance following the phone call. In the embodiment of FIG. 2, the switch 60 receives the disconnect message 76 containing the DisplayText information and transmits an INFO message 78 to the mobile station also containing the DisplayText information. As in the embodiment of FIG. 1, the mobile station 50 in FIG. 2 receives the INFO message 78 and shows the subscriber's new balance on the display 56.

Thus, with the embodiment of FIG. 2, within a relatively short period of time following the termination of a phone call (e.g., 3 seconds or less), the subscriber's mobile station automatically displays the new prepay balance. The subscriber advantageously does not need to wait for and listen to an audible, ephemeral message providing the desired prepay balance information. The displayed prepay balance can be made to be shown on the station's display 56 for a predetermined period of time or remain displayed indefinitely until the subscriber performs another action (e.g., activating a control on the mobile station).

The above discussion is meant to be illustrative of the principles and various embodiments of the present invention. Numerous variations and modifications will become apparent to those skilled in the art once the above disclosure is fully appreciated. Components can be added or removed from the circuits and different circuits altogether that provide the same benefits and functionality can be used. It is intended that the following claims be interpreted to embrace all such variations and modifications.

What is claimed is:

1. A method of providing prepay balance information to a wireless service subscriber's mobile station, comprising:
(a) sending a registration message to initiate registering the mobile station;
(b) receiving a message containing information indicative of the subscriber's current prepay balance; and
(c) displaying said information on a display associated with said mobile station.

2. The method of claim 1 wherein the registration message is sent in (a) upon powering on the mobile station.

3. The method of claim 1 wherein the registration message is sent in (a) after the mobile station has been powered on.

4. The method of claim 1 further including receiving the registration message sent in (a) and sending a registration notification message to a home location register.

5. The method of claim 4 further including receiving the registration notification message and sending a service request message to a prepay application to request the subscriber's prepay balance.

6. The method of claim 5 further including the prepay application retrieving the subscriber's prepay balance and sending a service request response message including a representation of the prepay balance.

7. The method of claim 1 including retrieving the subscriber's prepay balance and sending a service request response message to a home location register, said service request response message containing a representation of the prepay balance.

8. The method of claim 7 including receiving the service request response message and sending a registration notification response message containing said representation.

9. A wireless network providing wireless services to which subscribers subscribe, comprising:
a mobile station containing a display;
a switch to which said mobile station wireless communicates; and
a prepay application to which said switch communicates;
wherein said prepay application provides a representation of a subscriber's prepay balance through said switch to the display of said mobile station.

10. The wireless network of claim 9 wherein said prepay application provides said representation in response to said mobile station being powered on.

11. The wireless network of claim 9 wherein said prepay application provides said representation in response to said mobile station sending a request to be registered after already being power on.

12. The wireless network of claim 9 further including a home location register to which said switch and said prepay application communicate and wherein said mobile station sends a message to said switch to cause said mobile station to be registered and, in response, said switch sends a registration notification message to the home location register which responds by requesting said prepay application to retrieve and provide the representation of the subscriber's prepay balance.

13. The wireless network of claim 12 wherein said prepay application provides said prepay balance to said home location register via a service request response message.

14. The wireless network of claim 13 wherein said home location register provides said prepay balance to said switch via a registration notification response message and said switch transmits said representation to said mobile station.

15. The wireless network of claim 9 further including a home location register to which said switch and said prepay application communicate and wherein said prepay application provides said prepay balance to said home location register via a service request response message.

16. The wireless network of claim 15 wherein said home location register provides said prepay balance to said switch via a registration notification response message and said switch transmits said representation to said mobile station.

17. The wireless network of claim 9 wherein said mobile station comprises a cellular telephone.

18. A wireless mobile station including a display and wirelessly receiving prepay balance information from a wireless network wherein said mobile station shows said prepay balance information on said display.
